(19) United States
(12) Patent Application Publication
(10) Pub. No.: US 2003/0131229 A1
(43) Pub. Date: Jul. 10, 2003

(54) Method, system, and data structure for trustworthy digital document interchange and preservation

(76) Inventor: Henry M. Gladney, Saratoga, CA (US)

Correspondence Address: H.M. GLADNEY, 20044 GLEN BRAE DRIVE, SARATOGA, CA, 95070, US

(21) Appl. No.: 10/039,143

(22) Filed: Jan. 4, 2002

(51) Int. Cl. H04L 9/00

(52) U.S. Cl. 713/155

(57) ABSTRACT

Disclosed is a method, system, and data structure for digital document interchange and preservation whereby document originators, their agents, librarians, and archivists can make documents trustworthy and reliably meaningful to their recipients, no matter how far the recipients are in time, space, and organization from the aforesaid document sources. This invention works for all kinds of documents, independently of their purposes, independently of the kinds of information they convey, and independently of how this information is represented.

The mechanism combines prior standard and conventional data representations, emulation by means of Turing-equivalent virtual computers, a novel semantics of digital object identifiers that are copied into document packages, message authentication codes exploiting public key cryptography, and a certain discipline by which authenticating institutions make their digital signatures trustworthy.

### CROSS REFERENCE TO RELATED APPLICATIONS

U.S. Pat. No. 5,862,325 (US PTO Site), Computer-based communication system and method using metadata defining a control structure

U.S. Pat. No. 6,044,205 (US PTO Site), Communications system for transferring information between memories according to processes transferred with the information

U.S. Pat. No. 6,088,717 (US PTO Site), Computer-based communication system and method using metadata defining a control-structure

### STATEMENT REGARDING FEDERALLY SPONSORED RESEARCH OR DEVELOPMENT

Neither the research reported nor any invention claimed herein was sponsored by any governmental agency.

### REFERENCE TO A MICROFICHE APPENDIX

No microfiche is used in this application.

### BACKGROUND OF THE INVENTION

Interchange of digital documents is a growing activity that is accompanied by beginning attention to preserving documents for long periods—decades or longer. Such periods are longer than storage hardware technology lifetimes, and also longer than interpreting software can be expected to function properly. Two requirements are not completely met by prior art.

The first requirement is that, for some applications, digital document users will want or need assurance that the information obtained is “the real McCoy” and comes from the purported originators. The technical jargon for this is “assurance of the authenticity and provenance” of information received—that information received is sufficiently trustworthy for the application(s) at hand.

The second requirement is that any potential future user of each digital document should be able to render its digital representation (its bit stream(s)) comprehensible, even though he might not have the use of hardware and software technologies similar to those used to prepare the bit stream(s), and even though the originators are not available to answer questions. A realistic scenario is the situation of a human reader a century after a document set was stored.

The invention described herein describes novel elements of a method to accomplish these objectives. The claimed novelties work in conjunction with existing and proposed international data processing standards and inventions by other workers. This prior and developing art is incomplete for the stated objectives; we teach the design of components that complete what other workers have proposed.

1. Field of the Invention

Enabling users of digital documents to determine how trustworthy the information the documents convey is.

Ensuring that archived digital documents will be durably intelligible and useful to future readers, even though hardware and software technology used to prepare the documents is no longer available.

Fail-safe interchange of digital documents between incompatible hardware and software platforms.

2. Description of the Related Art

Since the objectives described under BACKGROUND OF THE INVENTION above pertain to all kinds of digitally represented documentary data and the invention at hand provides missing technology elements that combine with other technology, the reader should expect a long list of related art. For instance, the implementation of a digital preservation system is likely to exploit 100 or more ISO/IEC and ANSI information representation standards and proposed standards and conventions, including many that are rapidly evolving at the time of this application. Because this is such a complex field, with much essential detail, other authors have provided first-class bibliographies. For reasons of brevity and clarity, these are cited in the next two subsections instead of the primary literature they point at, together with brief descriptions of what they provide.

Most of the cited work is accessible in the World Wide Web. URLs are provided whenever possible.

Citations from Scholarly Literature

Directly pertinent prior art is tabulated here, and less directly pertinent work is tabulated in the next section. I.e., a complete system accomplishing the objectives of this invention almost surely uses elements of the work cited in this subsection in addition to the new elements taught below. In contrast, the work cited in the next subsection is intended to be helpful to understanding what problems are being solved and to an examiner's search for prior art.

[Beckett 01] Dave Beckett, Resource Description Framework (RDF) Resource Guide, http://www.ilrt.bris.ac.uk/discovery/rdf/resources/, 2001.

[Beit 01] Oren Beit-Arie et al., Linking to the Appropriate Copy: Report of a DOI-Based Prototype, D-Lib Magazine 7(9), September 2001. http://www.dlib.org/dlib/september01/caplan/09caplan.html

[Chadwick 96] D W Chadwick, A J Young, and N Kapidzic Cicovic, Merging and Extending the PGP and PEM Trust Models—The ICE-TEL Trust Model, 1996. http://www.darmstadt.gmd.de/ice-tel/reports/trustmodel.html

[CNRI 01] Corporation for National Research Initiatives, Handle System: A general-purpose global name service enabling secure name resolution over the Internet, http://www.handle.net/, 2001.

[Cover 01] Robin Cover, The XML Cover Pages, http://www.oasis-open.org/cover/sgml-xml.html, 2001.

[Dack 01] Diana Dack, Persistent Identification Systems: Report on a consultancy conducted for the National Library of Australia, May 2001. http://www.nla.goc.au/initiatives/persistence/Picontents.html. See also the Persistent Identifiers Webpage at http://www.nla.gov.au/initiatives/pesistence.html.

[Lorie 00] Raymond Lorie, Long Term Archiving of Digital Information, IBM Invention Disclosure AM9-99-0140, filed Feb. 25, 2000. Also, Long-Term Archiving of Digital Information, IBM Research Report RJ 10185, 2000. http://domino.watson.ibm.com/library/CyberDig.nsf/7d11afdf5c7cda94852566de006b4127/be2a2b1 88544df2c8525690d00517082

[Lorie 01] Raymond Lorie, Long-term Archiving of Digital Information, Proc. First ACM/IEEE-CS Joint Conf. on Digital Libraries, 346-352, Jun. 24-28, 2001. Also, A Project on Preservation of Digital Data RLG DigiNews 5(4), June 2001. http://www.rlg.org/preserv/diginews/diginews5-3.html#feature2

[Mactaggart] Murdoch Mactaggart, Enabling XML security: An introduction to XML encryption and XML signature, IBM DeveloperWorks, September 2001. http://www-106.ibm.com/developerworks/xml/library/s-xmlsec.html/index.html

[W3C 01] W3C/IETF URI Planning Interest Group, URIs, URLs, and URNs: Clarifications and Recommendations 1.0, W3C Note 21 September 2001. http://www.w3.org/TR/2001/NOTE-uri-clarification-20010921/

Additional Citations from Scholarly Literature

This invention targets information interchange over the Internet and other digital networks. Such interchange depends on many ISO/IEC, ANSI, and de facto industry standards, and the payloads that will be assisted by this invention will adhere to some of these standards. Although the invention itself does not intersect this prior art, parts of the preferred embodiment conform to such standards, as will be indicated in the text.

[CLIR 00] C. R. Cullen et al., Authenticity in a Digital Environment, published as CLIR Report pub92 (ISBN 1-887334-77-7), which is described at: http://www.clir.org/pubs/abstract/pub92abst.html.

[Feghhi 98] J. Feghhi, P. Williams, and J. Feghhi, Digital Certificates: Applied Internet Security, Addison-Wesley, Reading, Mass., 1998. ISBN 0-201-30980-7

[Gladney 01] H. M. Gladney, Audio Archiving for 100 Years and Longer: Once We Decide What to Save, How Should We Do It? J. Audio Eng. Soc. 49(7/8), 628-637, July/August 2001.

[Menezes 97] A. J. Menezes, P. C. van Oorschot, and S. A. Vanstone, Handbook of Applied Cryptography, CRC Press, New York, (1997). See also http://iitf.doc.gov/. ISBN 0-8493-8523-7

[MPEG-7] Motion Picture Experts Group (the ISO/IEC working group in charge of standards development for digital video), The MPEG Home Page, 2001.

[NZ 01] E-government Unit, New Zealand, S.E.E. Public Key Infrastructure, http://www.e-government.govt.nz/projects/see/pki/, 2001.

[Pulkowski 00] Sebastian Pulkowski, Intelligent Wrapping of information Sources: Gettiang Ready for the Electronic Market, Vala 2000 Conference, Feb. 16, 2000.

[Zbikowski] Mark Zbikowski. Brian T. Berkowitz and Robert L Ferguson, Meta-data Structure and Handling, U.S. Pat. No. 5,758,360, May 26, 1998 (Filed: Aug. 2, 1996).

### BRIEF SUMMARY OF THE INVENTION

The core of this invention is a digital document packaging structure that includes information relating the packaged documents with one another and with external documents, doing so in a way to make both the package content elements individually and their relationships more trustworthy than they would otherwise be. Furthermore, the packaging method ensures that the information will be interpretable for all time, even if its readers cannot ask questions of the information originator(s).

The preferred embodiment addresses the most difficult situation—effective communication of information originating today with some user remote both in space and time, e.g., some scholar who, a century from now, needs to know how trustworthy the information is, and who needs to understand the content that might include technical diagrams, mathematical expressions, scientific and geographic data, and corporate financial reports. Furthermore, the information to be comprehended might include representations of theatrical performances that must be viewed and heard for full appreciation. It might also include various kinds of computer programs, among which the most demanding are simulations, such as battlefield simulations, whose value is achieved only by execution. The input carrying all these kinds of information might be a document set that the scholar finds in some research library or in Internet storage repositories, and institutions certifying certain properties of this information might be research libraries like the Library of Congress.

However, there are simpler and more immediate applications, including but not limited to commands sent from one computer to another in a digital communication network, financial instruments for securities transactions, digital instructions to machine tools, bills of materials and other documents essential to manufacturing operations, and e-commerce orders.

Most generally, the document structure taught contributes to enabling useful communication between digital machines that otherwise could not work together. Such communication is generally made effective by exploiting standards for inter-machine communication. The invention extends such pre-existing methods by elements that nobody has previously considered.

### BRIEF DESCRIPTION OF THE DRAWINGS

FIG. 1 illustrates the prototypical computer and digital communications environment.

FIG. 2 illustrates an input object consisting of an arbitrary number of documents and metadata blocks.

FIG. 3 illustrates trustworthy packaging of the object illustrated in FIG. 2.

FIG. 4 illustrates the structure of a value set for use in several places in a trustworthy package.

FIG. 5 provides detail of the structure of the Protection Block (PB) suggested in FIG. 3.

FIG. 6 provides detail of FIG. 3, emphasizing structure used to seal the PB, the payload, and associated reference information in order to prevent undetected tampering with the packaged information.

FIG. 7 and FIG. 8 provide context for the use of a previous invention (by Raymond A. Lorie) and the method whereby the current invention creates a durable and trustworthy association of separate digital objects that need to be safely associated over long periods of time. Specifically, FIG. 7 helps describe how complex data is made interpretable in the future, and FIG. 8 helps describe how computer programs can be made executable in the future.

### DETAILED DESCRIPTION OF THE PREFERRED EMBODIMENTS

Terms of Reference

In this invention, the distinctions between various information kinds and purposes are deliberately irrelevant; it applies to recordings of theatrical presentations, scientific data, computer games, and to any other kind of information that might pass between a source human being or source machine and a target human being or target machine. Thus, appellations such as “author”, “artist”, “musician”, “composer”, and so on are effectively synonyms; generally, we use “originator” for any such person except when doing so would make the description stilted.

Similarly, other conventional English words for the roles of individuals in the use of information (e.g., “reader”), the machine functions (e.g., “print”), and the information exchanged (e.g., “document”) are usually too narrow. Where their use would otherwise be ambiguous, the reader should construe them as widely as seems reasonable. The following tabulation of terms of reference defines some words and phrases whose precise meanings are important to this invention and not entirely conventional.

| | |
|---|---|
| Bit stream | sequence of binary characters; a synonym for file or |
| | dataset used to emphasize that it denotes an informa- |
| | tion representation readily transmitted via a serial |
| | channel or stored on a disk or tape. |
| Data object | digital representation of any kind of information; often |
| | used as a synonym for document (q.v.), file, dataset, |
| | video signal, drawing, image, . . . |
| Document | digital representation of any kind of information, such |
| | as commands, text, photographs, video or audio infor- |
| | mation, scientific tables, spreadsheets, computer |
| | programs both simple and complex, . . . or any ordered |
| | or unordered combination of such specialized kinds of |
| | information. |
| Eye catcher | a bit string or character string used as a search target in |
| | order to locate other information whose content and |
| | format cannot be predicted. Typically, the eye catcher |
| | immediately precedes the information of interest. |
| Originator | person or organization that creates a document |
| | intended to be communicated to others, either directly |
| | and soon, or by way of intermediaries such as archives |
| | and research libraries that hold the document for long |
| | and unpredictable periods. |
| Link | a connection between a location within a data object |
| | with some other location within a data object, which |
| | might be the same object or another object. In this |
| | invention, “link” is a synonym for “reference” and for |
| | “pointer”. |
| Metadata | information describing a document with text elements |
| | and other information needed for using or managing |
| | the document and usually not contained in the |
| | document itself. Often metadata is created and attached |
| | to a document by someone other than the document |
| | originator. E.g., a library cataloguer might create |
| | metadata for a book, doing so because she does not |
| | want to alter the book as delivered to her by its author. |
| Ontology | In Al and Knowledge Engineering, the hierarchy of |
| | objects and properties in a representation system; more |
| | simply, the notion that in order to understand identi- |
| | fiers, you have to understand what kinds of things |
| | “exist” to be identified and the mutual relationships of |
| | these object kinds. |
| Payload | set or sequence of one or more payload elements |
| | (q.v.). |
| Payload element | document or data object, optionally accompanied by |
| | zero or more metadata objects. |
| Protection block | new type of metadata block that is part of this inven- |
| (PB) | tion, and described below. |
| Reader | a human being or a digital machine that usefully |
| | interprets documents it obtains or receives, independ- |
| | ently of the kind of information. E.g., if the informa- |
| | tion is a musical performance, reader is a synonym for |
| | listener. |
| Resolver | a network service that accepts the name or identifier of |
| | a digital object and, either alone or by cooperation |
| | with other resolvers, returns the network addresses of |
| | storage servers that can deliver objects with the name |
| | provided. |
| Trustworthy | describing information deserving people's confidence |
| | that it can prudently be used for its announced |
| | purposes. Specifically in this invention, this includes |
| | that a user is able to test that information purported to |
| | come from announced authors has not been tampered |
| | with by third parties and that it surely originates with |
| | the purported author(s). |
| Trustworthy | the kind of digital object whose production, |
| Digital Object | advantages, and beneficial uses are taught by the |
| (TDO): | current invention. |
| Trustworthy | an identifier for and in a TDO (q.v.), i.e., a byte string |
| Digital Object | whose properties and uses are similar to those of so- |
| Identifier (TDOI): | called URIs. It might be a URI [W3C 01]. |
| Trustworthy | an institution or enterprise that can be trusted to certify |
| Institution | faithfully the authenticity of documents and other |
| | critical information, such as the association of a public |
| | key with an individual or another institution. For |
| | instance, for scholarly documents this might be a |
| | national library such as the U.S. Library of Congress. |
| | Depending on the application area, it might otherwise |
| | be a bank such as Barclay's Bank, a government |
| | agency such as the U.S. National Archives and |
| | Records Administration, a private enterprise such as |
| | IBM, or any other kind of institution that some |
| | community trusts sufficiently for its certifying role in |
| | protecting some class of digital documents. |
| URI, URN | “Uniform Resource Identifier” and “Uniform Resource |
| | Name” respectively-used for objects in the World |
| | Wide Web. See [W3C 01]. |
| UVC | “Universal Virtual Computer”, a Turing compatible |
| | computing machine; see [Lorie 00] for a preferred |
| | embodiment. |

Other specialized terms used in this patent application are common and widely used industry jargon that can be found in one or more of the citations above.

Computing Environment and the Trustworthy Digital Object (TDO)

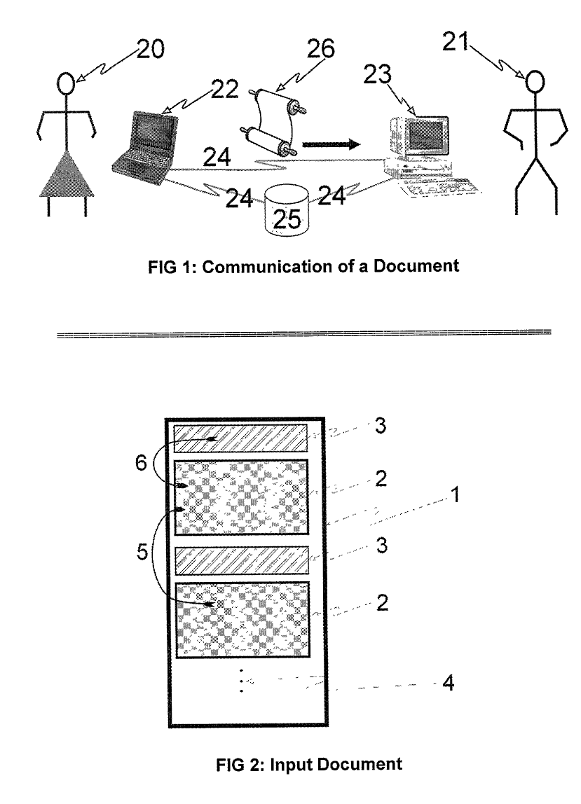

This invention operates in a computing environment (FIG. 1) in which some originator 20 uses a digital device 22, commonly called a (network) client, to convey some document 26 to some reader 21. Said reader 21 uses a digital device 23, commonly also called a (network) client, to acquire and read or otherwise make use of the information embodied in the document 26. The document 26 is transmitted by means 24 that might be a telecommunications channel or a material substrate such as a computer diskette, with optional temporary delay being managed by holding a copy of the document 26 in storage 25 that might be managed by parties unknown to the orginator 20, or to the reader 21, or to both 20 and 21. Although the means of transmission 24 and storage 25 preferred in this invention are digital networks and magnetic disk storage, they might be any other effective means, such as the U.S. Post Office and a CD respectively.

The document created by an originator 20 for the eventual benefit of some reader 21 is called a Trustworthy Digital Object or TDO below.

The transmission might be either synchronous and triggered by concerted actions by the originator and reader, or asynchronous, with the originator causing the object to be deposited in storage 25 from which the reader causes the document to be recovered later—possibly many years later. The originator 20 might create the TDO for some known set of users 21 or might be entirely ignorant of the identities of these eventual users.

The TDO might be constructed, transmitted, and read for any useful purpose whatsoever. That is, it might represent a scholarly manuscript, an artistic performance, an engineering specification, a medical patient history, a purchase order for goods or services, a computer program together with its documentation, a military command, a command from one computing device for execution at another computing device, or any other information whatsoever. The purpose of the invention is to make the transmitted information more trustworthy and more durably useful than it would otherwise be.

As suggested by the FIG. 1 depictions of the originating computer device 22 and the receiving computer device 23, the information transfer occurs between terminals of potentially different hardware and software architecture. What enables intelligible transfer from 22 to 23 is that the document 26 is structured and formatted according to commonly understood rules embodied in international standards or de facto publicly known conventions to which the terminal devices conform by a large number of hardware and software accommodations. The current invention adds to such prior art.

Specifically, this invention teaches aspects of the packaging and semantics for rendering digital documents more durable and trustworthy than they would otherwise be, and neither teaches anything about the syntax or language of such rendering nor is limited to any particular syntax set. However, no information can be represented without a syntax set understood both by its originator and also by its intended receivers. Our preferred embodiment uses XML syntax; XML has been and is being addressed in international standards activities whose documentary records are mostly WWW-accessible [Cover 01].

A full implementation necessarily includes computer programs that execute in the originating and the exploiting machines, 21 and 23 respectively. Given the data structure taught in this invention, such programs can be implemented with prior well-known methods. I.e., the invention is embodied primarily in the data structure taught below.

Information Structure

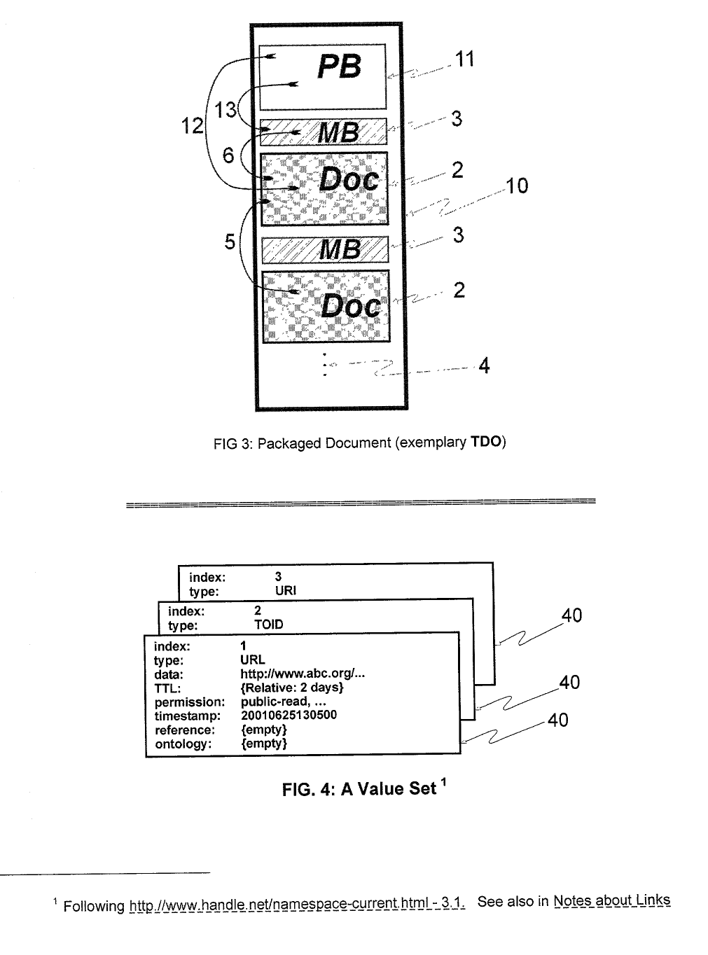

FIG. 2 illustrates an input object 1 that is provided by the originator 20 using the device 22. This input object can convey any information whatsoever using representations comprehensible by the reader 21 with the aid of the device 23. However, if 22 receives the input object “as is”, he might find it contains elements he cannot exploit (e.g., because they are computer programs for a different kind of machine than 23) or deem it insufficiently trustworthy for the application at hand. I.e., the input object 1 is not trustworthy in the sense this invention provides for; the invention is a method for transforming the input object 1 into a TDO.

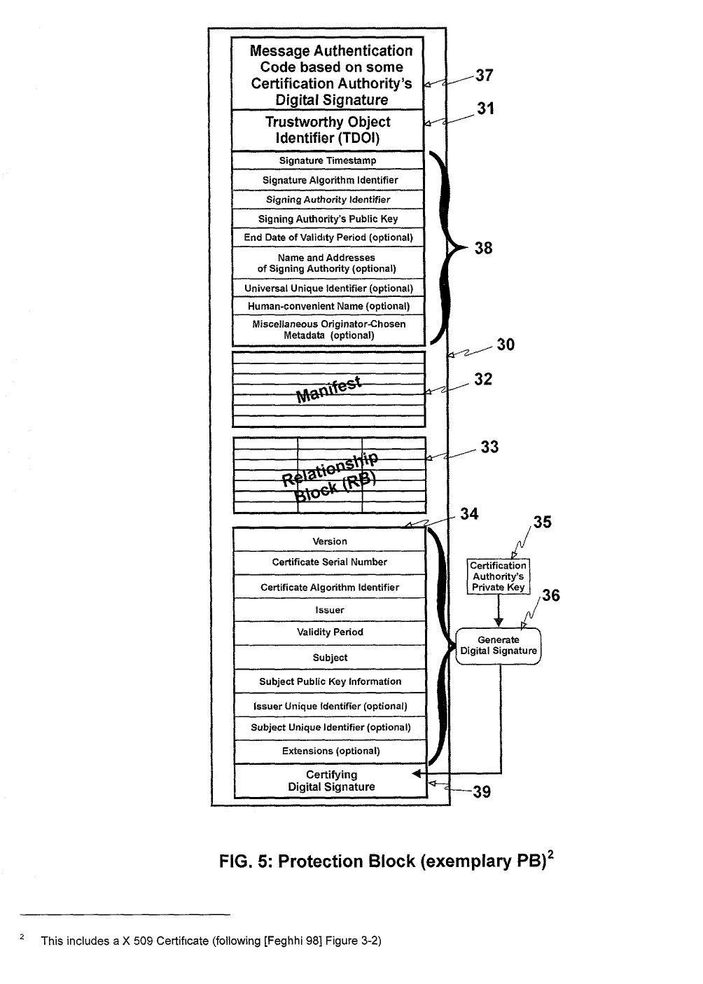

FIG. 2 further illustrates that the input object 1 might be made up of any number of documents (abbreviated Docs) or digital objects 2 and any number of metadata blocks (abbreviated MB and also called metadata elements) 3. Portions of the order of these elements might be significant to users, or the entire order might be significant, or ordering may have no meaning to users of this information. In any case, the contained objects must occur in some order for transmission across serial channels and perhaps for other processing purposes. We presume that the originator 20 chooses and conveys some ordering as part of delivering the input object 1, and that this the orderings deemed significant. We preserve this ordering when we build the contents of the input 1 into the TDO 10 (FIG. 3) and use this conveyed ordering as an index that identifies blocks of data.

The content objects might include pointers or references 5, each from some object 2 to some other object 2, and also pointers or references 6, each from some metadata block 3 to some object 2. Although pointers ending in metadata objects 3 are unlikely and therefore not shown, they might occur; such occurrences will not materially affect what is described below. Any number of pointers—zero or more—of any mixture of kinds might occur.

Collectively, Docs and MBs are called payload elements below, and any collection of these that might be communicated or stored is called a payload.

Although FIG. 2 shows one metadata block 3 for each digital object 2, the numbers and associations to documents of metadata objects provided by input sources can be whatever the originator 20 chooses. A metadata block might be related to any number of documents, including zero documents, and any document might have any number of associated metadata blocks, including the possibility of zero such blocks. This is suggested in the figure by the “and so on” symbol 4.

FIG. 3 illustrates a trustworthy packaging—a TDO. The object 10 is built from the object 1, which it includes entirely without change, by the addition of one or more metadata blocks 11 that optionally include references to and/or into the portions 2 and 3 of the input object 1. This block 11 is a new type of metadata block called a protection block (abbreviated PB) in the text below, where its content and structure is described. As suggested by FIG. 3, a TDO consists of information blocks or files laid out in a sequential order so that the TDO can be transmitted over a single information channel. Alternatively and for convenience in processing, a TDO might be differently laid out in computer memory or on digital storage disks and tapes; if this is done, the representation includes sufficient information so that the serial transmission format can be reconstructed in its canonical order.

FIG. 3 illustrates also that, since a protection block (PB) is also a metadata block (MB), any TDO might itself be part of a payload within a trustworthy packaging. I.e., TDOs can be nested and it is frequently valuable to do so.

Value Set Structure to Express Attributes Flexibly

FIG. 4 illustrates a value set, which follows structure described in [CNRI 01]. Each value 40 has a unique index number that distinguishes it from the other values of the set. Each value also has a specific data type that describes the syntax and semantics of its data, and each value has associated administrative information such as TTL (time to live) and permissions. Each value has an optional ontology field that is usually empty, and otherwise contains the URI for an ontology that conveys the meaning of the data field, as described in publications cited by [Beckett 01].

Such complex value records, which are also referred to simply as TDO values, are used in various places in the Protection Block described in the next section. (Note that the encoding of the length for each field is not shown in FIG. 4.)

Protection Block (PB) Content and Structure

FIG. 5 illustrates that a PB 30 consists of a TDOI 31, an optional manifest 32, an optional relationship block (RB) 33, and zero or more X.509 digital certificates 34.

FIG. 5 further suggests a procedure for generation of digitally signed message authentication codes. Some certifying authority working in a secure environment fills in its public key and any other missing information into the certificate 34, creates a cryptographic hash of the information to be sealed, and then uses its private key 35 to generate the certifying digital signature 39. Computer programs 36 to accomplish this are well known, as are programs to check that the signed data (all of 34 except for the signature itself) corresponds to the signature, i.e., has not been changed after being signed.

The TDOI 31 is extended by fields 38 used to hold essential and non-essential information related to digital signing described below. The essential fields enable whoever reads the TDO to validate that it has not been altered by anyone other than the owner of the included public key; these include a timestamp, a signature algorithm identifier, a signing authority identifier and the signing authority's public key value corresponding to the timestamp. The non-essential information might be anything expected to be useful to the TDO reader 21 and not otherwise easily available in the TDO, such as an ASCII representation of the signing authority's name, address, e-mail address, telephone number, etc., and such as a date beyond which the signer thinks the document no longer useful for its intended purpose. For instance, if the document is an electronic ticket to a sports event, it would not be useful after the event ends.

Each field in 38 is encoded according to widely published specifications and standards. E.g., the timestamp might be encoded as an 8-byte (long) integer that records the last time the value was updated at the primary server that manages the handle value; it might contain elapsed time since 00:00:00 UTC, January 1970 in milliseconds.

The PB might include a manifest 32 that is a sequence of value sets. Each such value set describes the corresponding payload block, i.e., the nth manifest element describes the nth payload block.

The PB might include a relationship block RB with any number of rows. Each row 33 is a sequence of three cells. Each of the first and last cells of a row contains an object identifier as described in the next two sections, or the identifier of an external object, or a bookmark into either kind of object. External identifiers and bookmarks can conform to any of several well-known rule sets for such linking information. The middle cell describes the relationship between the two objects identified. This is encoded as a value set as described in the prior section; the value set might identify further objects either within the TDO or external to it; i.e., the PB structure imposes no bound to the detail in which relationships can be described.

The PB might further contain any additional information deemed valuable to future users, especially additional information thought useful for making the authenticity and provenance of the TDO more trustworthy, such as information about digital watermarks and fingerprints applied to payload elements.

Trustworthy Digital Object Identifier (TDOI) Syntax and Semantics

The Trustworthy Object Identifier (TDOI) 31 consists of a prefix and a suffix. All TDOIs have the same prefix. This prefix is a string chosen to avoid collision with the prefixes used for other identifier classes (see below) and long enough to be useful to search engines as an eye catcher. In this preferred embodiment, this eye catcher is chosen to be “TDOI:”.

The suffix is a character string unique to each set of TDOs whose originators decide to share some TDOI value. This is a long string chosen in such a way that the probability of accidental equality to an independently chosen TDOI is very small, e.g., 1 chance in 10²⁰. There are several well-known ways to accomplish this. Its preferred encoding is with ASCII characters and with any other restrictions helpful to avoiding difficulties in legacy systems which might need to process TDOs.

TDO originators choose whether a new TDO is to have a new TDOI or the same TDOI as some already-existing TDO. Presumably the latter will mostly be for later versions of some earlier document, but there is no restriction that this be the case. For example, an author might package his book submission to a publisher as a TDO, signed with the author's public key. The publisher's editorial staff might package its extensively revised version of the book as a TDO with the same TDOI as the author supplied, and sign this version with its own public key and timestamp. This publisher's version might include not only its own PB, but also the PB supplied by the author. The publisher might share this version with a copyright depository library and pay a certification fee to have this library build a new TDO that includes the publisher's version together with standard cataloguing metadata; this new TDO would be packaged with the library's public key and timestamp, and would again use the TDOI first provided by the author. The publisher might then distribute copies widely, i.e., publish this version.

When the time comes to issue a revised copy, a similar sequence of steps might be followed with a revised manuscript, and each of the author's TDO, the publisher's TDO, and the copyright depository library's TDO might include ancillary information that enhances the work. For example, if the book is about digital computation, the author might include new sample programs, the publisher might include promotional material and links to Internet sales sources for related software, and the library might include information about interest group bibliographies. Again, the publisher might distribute copies widely.

For this example, we further assume that the library's public keys are trustworthy, that the library has been diligent in checking that the publisher's public keys are valid, and similarly that the publisher has checked that it can trust the author's public key.

Suppose further that the book becomes famous and that eventually (say, after copyrights have expired) both the first publisher's version and the second publisher's version are put on the WWW, i.e., stored on a public Web site that is accessible to the popular search services. Then some reader who finds a version of the work could request all works with the same TDOI. She would receive, after filtering to remove duplicate TDOs, two versions. From their protection blocks, she would infer their provenance and relationship. From the library's timestamped signatures she would further be able to trust all the information received to the extent that she trusts the library's dedication and ability to have made correct validity tests many years earlier. Furthermore, she can compare the innards of the two TDOs both for further tests of validity and to discover document history details of kinds that sometimes interest scholars.

Notice that the TDOI 31 concatenated to the timestamp that heads the fields 38 conforms to all the rules for a valid IETF Uniform Resource Name (URN, aka “Uniform Resource Identifier (URI)”) in the applicable international standards, except that its syntax might be different. Thus, this combination can be used instead of a URN or URI wherever these might otherwise occur, conferring all the benefits of such identifiers.

Other Identifiers and Locators

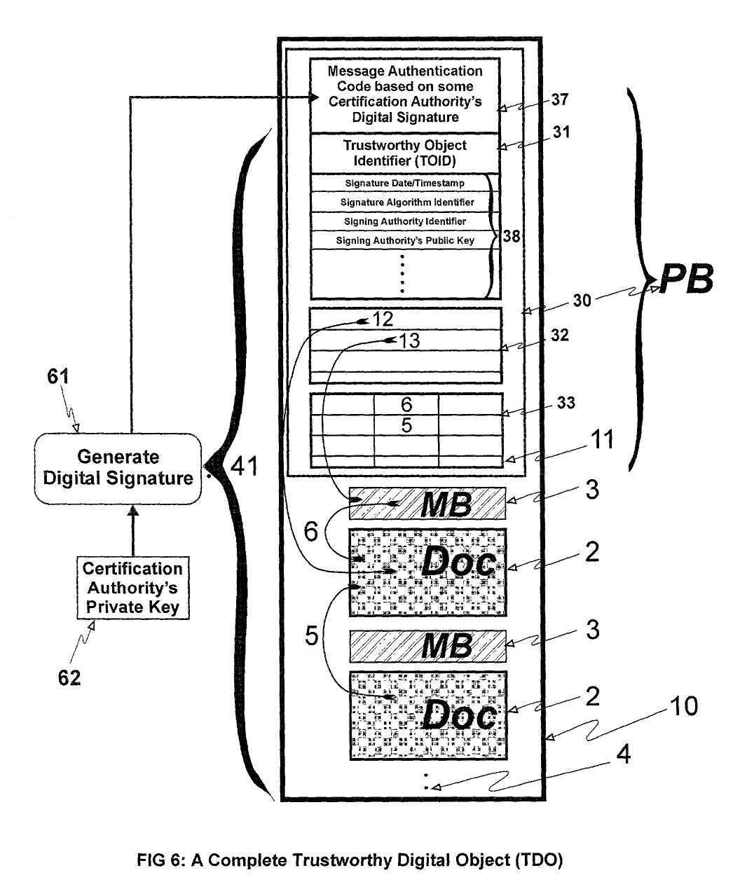

Anywhere a TDOI might stand, except in the position 31 shown in FIG. 5 and in FIG. 6, any other form of identifier or locator might be used, including but not limited to instances of the following well-known identifier and locator classes. The only limitations are that, to be useful, an identifier must conform to some well-known international standard or widely published convention, and that the specific pertinent convention be unambiguously conveyed by the identifier.

| | |
|---|---|
| Digital Object Identifiers (DOIs), such as | 10.1000.10/123456789 |
| International Standard Book Numbers, such as | ISBN 1-861003-11-0 |
| Social Security Numbers, such as | US SSN 461-34-7155 |
| International Telephone Numbers, such as | Telnum 1-415-520-1234 |
| Uniform Resource Locators (URLs), such as | http://www.abanet.org/ |
| | ftp/pub/scitech/ds-ms.doc |
| Uniform Resource Name of Object Identifiers, | urn:oid:1.3.6.1.2.1.27 |
| such as | |
| Vehicle numbers, driver's license numbers, | |
| passport numbers, and so on. | |

Some such classes require disambiguation to avoid collisions between instances in different classes, and are given obvious prefixes; this is illustrated above by the Social Security Number and telephone number examples. Other classes already have standard disambiguating prefixes and can be used as is conventional in other applications; this is illustrated above by the URL and ISBN examples. All such identifiers and also TDOIs are called “external identifiers” below whenever it is important to distinguish their treatment from that of “internal identifiers” described below. However, external identifiers are mostly used the same way as internal identifiers.

Some of these forms may be extended by offsets into the content, or bookmarks. This is often indicated by a “#” sign followed by a bookmark name or an offset. This convention can be extended from those standard identifiers that use them to others that need, but do not define, such offsets. For instance, this might be extended to include page numbers of printed books.

These identifier types include a special type—called an internal identifier below—that identifies information blocks within the TDO itself. Instances of this type are denoted by non-negative integers, each identifying a block in the TDO. The integer “0” identifies the Protection Block 11 in FIG. 3 and positive integers identify the subsequent blocks in order.

Furthermore, any block 2 in FIG. 3 might itself be a TDO. If so, it is considered to be similarly numbered, and the symbol “.” is used as punctuation that separates portions of a compound identifier. Thus the identifier “3.2” would indicate the second internal payload data block within the third payload block of the current TDO and “5.0” would identify the PB of the fifth payload block of the current TDO; i.e., surely “5” indicates that the 5^{th} payload block is itself a TDO. In contrast, the information given so far does not convey whether the third payload block is a TDO or not.

Identifiers “0.n”, where “n” is an integer, identify the data blocks that make up the PB. In FIG. 5, each of 31, 37, and the individual fields of 38 is counted as a block, as is the manifest 32, the relationship block 33, each instance of a certificate block 34, and such other kinds of blocks as might be defined for protection block inclusion in the future.

Rows within the manifest 32 are also assigned identifiers following the same scheme as described above for payload blocks within payload blocks, starting with “1” for the first manifest row. I.e., in FIG. 6, 0.1.5 identifies the fifth manifest row, which itself describes the fifth payload element, i.e., the payload block identified as “5”.

Internal identifiers, like external identifiers, can be extended by offsets and bookmarks; the syntax and semantics of such offsets and bookmarks are identical for internal and external identifiers.

Making a Digital Object Trustworthy by Digital Signing

As illustrated by FIG. 6, to make a sequence of data objects into a TDO, the sequence of information blocks, consisting of a PB 30 followed by some metadata blocks and documents in this input order, is preceded by a signed message authentication code 37. This code is constructed by calculating from the body 41 by well-known methods for rendering a digital object resistant to undetected alteration. This calculation is done by the program 61, which is fed the private key 62 to do the signing.

Construction of the message authentication code 37 is done by an institution, such as the Library of Congress, that is widely trusted for certification of document classes that include the document at hand. Each such trustworthy institution would have previously published descriptions of the properties of documents it offers to certify, and also public keys, one for each time period in which certifications have occurred. Institutions make themselves trustworthy by publishing their certification criteria and by persuading its intended clients, which might be the entire citizenry, that the institution depends in essential ways on its reputation for integrity.

Such institutions optionally enlarge the communities that trust them by certifying each other's public keys, to create a so-called “Web of Trust”, doing so by each such institution widely publishing signed public key certificates endorsing the public key to institutional identification mapping of sister institutions. This is made safe by “out of band” communication of public keys. E.g., at the annual meeting of the American Library Association, a representative of Harvard University Library might exchange public key diskettes with a representative of the Princeton University Library; then Harvard might publish a Harvard-signed certificate endorsing that the Princeton key so transmitted belongs to the Princeton library, and vice versa.

Shortly after such a trustworthy institution receives an input document from its originator, it would test this input and its knowledge of the originator to determine whether they satisfy its published criteria for document certification. If it believes its criteria are satisfied, it copies the document into a digital computer that it can detach from all digital networks and that is guarded against containing any pertinent secret while it is attached to any digital network. A machine operator then detaches this computer from all networks and provides it the private portion 62 of the public/private key pair that will sign the document (e.g., this secret key might be on a computer diskette). He then invokes a program that fills in all missing PB portions, doing so by well-known means 61 of providing cryptographic message authentication codes and essential metadata, such as identifiers of the algorithms used, ensures that the document has canonical XML form, and creates and signs the message authentication code 37, thereby completing the TDO construction. Finally, he removes the aforementioned secret information from the signing machine, and then re-attaches this machine to such digital networks as are needed to communicate the TDO to whatever repository 25 it should be stored in and/or back to whoever requested the message authentication.

In order to protect its private key further, and also in order to provide users with extra assurance of the age of TDOs it has signed, the trustworthy institution changes its public/private key pair periodically—annually for instance—and destroys all copies of the private key, which need never again be used. By such measures and related business security controls, it makes misappropriation of its private keys sufficiently difficult to be unattractive to would-be fraudulent agents. (How careful is careful enough will depend on the kind of documents that the private key will be used to certify, e.g., keys for large funds transfers will require more care than keys for certifying scholarly publications.)

Making Programs and other Complex Data Interpretable

The method described in the sections above is sufficient when every data object 2 of FIG. 2 belongs to a data type that is simple enough to be described completely by data standards, and that occurs sufficiently frequently that standards bodies have seen fit to provide such complete specifications. (For reference below, we call this case O treatment for ordinary data objects.) For computer programs and other data objects that do not meet the criteria for case O treatment, we provide another method; this builds on a prior invention by Raymond Lorie.

[Lorie 00] and [Lorie 01] teach making complex data and computer programs interpretable in the distant future. This method works even when the computing machines and software used to create and use such data and programs cannot be used when someone is interested in the stored data. However, Lorie does not teach a reliable way to associate separate computer files over long periods of time. What follows provides for this need.

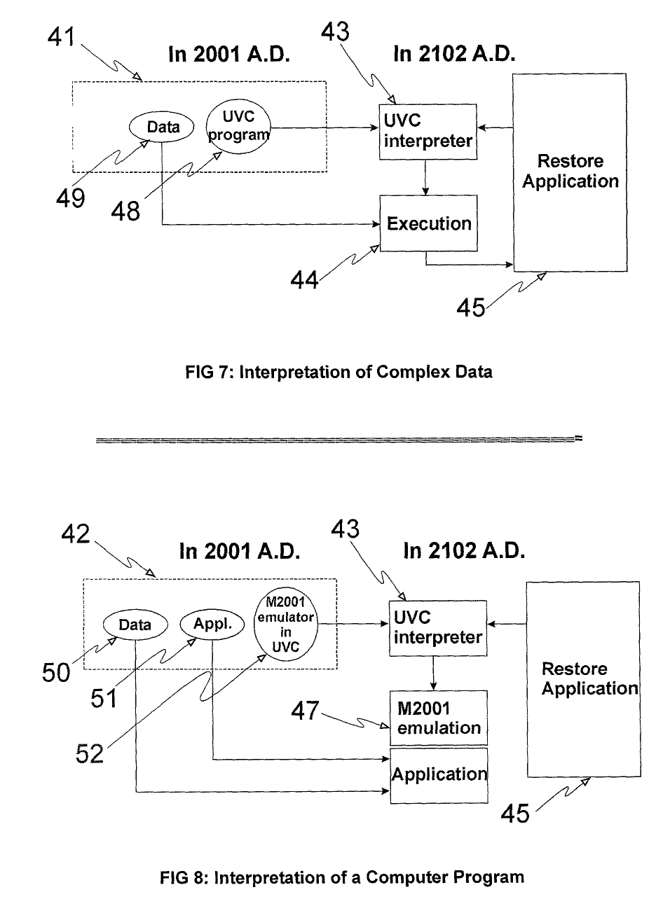

There are two cases. In case D illustrated by FIG. 7, complex data is to be propagated; in case P illustrated by FIG. 8, a computer program is to be propagated. In both cases, Lorie teaches that a “universal virtual computer” (UVC) provides for making computer programs that work on 2001 A.D. (for instance) hardware and software reliably executable in 2102 A.D. (for instance) with whatever technology is available then. This UVC is computationally equivalent to a Turing machine. It is called “virtual” because no physical implementation is needed; instead, instances are realized by emulations that execute in digital environments available whenever UVC instances are needed.

In case D (FIG. 7), we save a UVC program 48 bound to the data 49 needing future interpretation. This UVC program 48 is interpreted in 2102 A.D. by a UVC interpreter 43 written to operate in a 2102 digital environment M2102 and to work on the saved data 49. Each of 48 and 49 is a data object that we save as a 2 instance (see FIG. 6) together with such metadata 3 as might be needed by the restore application 45 executed in 2102 A.D.

In case P (FIG. 8), we save not only the application input data 50 and the computer program 51, which is a program for today's computer (called M2001 in the figure), but also an emulator for M2001. This emulator 52 is written as a UVC program. In 2102 A.D. when the objects 50 and 51 are to be used again, a restore application 45 uses a UVC interpreter written in the code of the 2102 A.D. machinery to translate the object 52 into a M2001 emulator 47 written in the code of the M2102 machine. This program 47 executes the application 51 on the data 50. I.e., we save 50, 51, and 52 and perhaps auxiliary metadata together in a way that some 2102 A.D. user in can trust that these data objects are related as needed to accomplish the 2102 A.D. interpretation task suggested by FIG. 8.

We save any object set Y for either case D or case P treatment with the TDO structure described in prior sections and illustrated in FIG. 6. Any additional data objects whose associations with Y are important we include these objects in the same package. I.e., the payload of a TDO includes whatever combination of data objects needs to be reliably associated, including objects variously requiring O, D, and P treatment. The manifest 32 indicates the treatment needed for each object, and relationship rows in 33 indicate which object pairs 48 and 49 belong together (for D instances) and which object triples 50, 51, and 52 belong together (for P instances).

Since the emulator 52 is likely to be used with many 50, 51 pairs, we can save it as replicas in the worldwide network. If we do this, we assign it a URI in place of the TDOI that we would use if we communicated the emulator as TDO content. We would record the URI of such an externally held emulator 52 in the appropriate slots of the relationship table 33.

Using a Trustwothy Object

A computer program helps the reader 21 (in FIG. 1) inspect and test a TDO (see FIG. 6), and also to extract portions of interest. The user might receive the TDO as part of a communication 24 either from the originator 20 or from some third party (not shown). He can without further ado and with the aid of the manifest 32 extract and use the objects of interest. Alternatively he can use the contents of the PB 30 together with published information about public key values and testing policies of the signing institutions to assess the trustworthiness of the payload elements 2 and 3 and links 5 and 6 conveying relationships between payload elements. He can execute such tests with varying thoroughness as needed by his application. How to write computer programs for such tasks is well known to EDP practitioners.

Alternatively, the reader 21 might find a TDO by searching in the Internet. How we enable searching is described below. After the user locates and downloads a TDO, he continues as described above.

Finding and Choosing a Trustworthy Digital Object (TDO)

A reader might learn of some TDO 63 (not shown in the figures) by communication of its TDOI 64 (not shown) by someone else, or by the TDOI 64 being mentioned in another document. Since 64 identifies the object but does not indicate where any copy is located, the reader would ask for a name-to-address resolution. This would be by query to a name-to-address resolver service such as that described in [CNRI 01], which would return a set of URLs associated with satisfying digital objects and, optionally, their signing timestamps (see the head item of 38 in FIG. 5). This information is sufficient for the reader to eliminate duplicates, to obtain all the accessible distinct TDOs with this TDOI, and to select those instances that interest him, possibly using optimizations such as that described by [Beit 01].

How to construct a resolver database of the kind alluded to in the prior paragraph is taught by [CNRI 01] and publications it alludes to.

Alternatively, a reader 21 might search for documents using well-known Internet search services. To ensure that she finds satisfying TDOs, the crawler portions of search services would search for instances of the eye catcher described above under Trustworthy Digital Object Identifier (TDOI) Syntax and Semantics above, extract the TDOIs, and construct a database mapping TDOIs to URLs. Furthermore, such a crawler could detect and exploit the other useful information in each PB 31, such as the optionally included URI. With this, such services would be able to service reader 21 requests, returning URL sets of at least three different kinds: (1) just those URLs satisfying the query; (2) all the URLs of (1) augmented by all URLs whose TDOIs coincide with TDOIs found in the response (1); or (3) the response (2) pruned to remove URLs for duplicate TDOs. Given such services, readers would proceed by well-known methods of information retrieval.

1. A method for packaging information objects wherein the package includes an identifier of the package object itself and the whole is sealed by cryptographic message authentication

2. The method of claim (1), wherein the private key portion of a public/private key pair used for sealing is protected by use only in subsystems disconnected from networks and, optionally, is frequently replaced.

3. The method of claim (1), wherein a public key associated with the claim (2) private key is published and optionally endorsed by a certificate signed by an institution other than that to which the keys alluded to in claim (2) belong, with this endorsing institution having a business dependency on its reputation for care, know-how, and integrity.

4. The method of claim (1), including within the package a record describing a link between two information objects by referencing their identifiers or indices.

5. The method of claim (1), including within the package metadata recording a value that binds an external object defining a well-known ontology to an included payload element or link.

6. The method of claim (1), wherein an information object X included in the new package Z is itself packaged as described in claim (1) and wherein the identifier of Z alluded to in claim (1) has the same value as the identifier of X.

7. A method for packaging an information object with metadata not otherwise provided, where such metadata includes software or instructions for interpretation of the information object, or alternatively contains a reference to a durable external deposit of such software or instructions.

8. The method of claim (7), wherein the information object and the information enabling its interpretation are bound together by a cryptographic message authentication code.

9. The method of claim (7), wherein the software for interpretation is encoded with the instruction set of a machine, called a Universal Virtual Computer (UVC), that is simple enough for complete specification so that it can be emulated without error or omission by any sufficiently skilled third party who has the specification of this UVC.

10. The method of claim (7), wherein the software and instructions alluded to implement well-known methods that are made reliably interpretable by their schema being standardized and identified by or included in the package.

11. A system for packaging information objects wherein the package created includes an identifier of the package object itself and the package is sealed by cryptographic message authentication.

12. The system of claim (11), wherein the private key portion of a public/private key pair used for sealing is protected by use only in subsystems disconnected from networks and, optionally, is frequently replaced.

13. The system of claim (11), wherein a public key associated with the claim (12) private key is published and optionally endorsed by a certificate signed by an institution other than that to which the keys alluded to in claim (12) belong, with this endorsing institution having a business dependency on its reputation for care, know-how, and integrity.

14. The system of claim (11), including within the package created a record describing a link between two information objects by referencing their identifiers or indices.

15. The system of claim (11), including within the package metadata recording a value that binds an external object defining a well-known ontology to an included payload element or link.

16. The system of claim (11), wherein an information object X included in the new package Z is itself packaged as described in claim (11) and wherein the identifier of Z alluded to in claim (11) has the same value as the identifier of X.

17. A system for packaging an information object together with metadata not otherwise provided, where such metadata includes software or instructions for interpretation of the information object, or alternatively contains a reference to a durable external deposit of such software or instructions.

18. The system of claim (17), wherein the information object and the information enabling its interpretation are bound together by a cryptographic message authentication code.

19. The system of claim (17), wherein the software for interpretation is encoded with the instruction set of a machine, called a Universal Virtual Computer (UVC), that is simple enough so that it can be emulated without error or omission by any sufficiently skilled third party who has the specification of this UVC.

20. The system of claim (17), wherein the software and instructions alluded to implement well-known methods that are made reliably interpretable by their schema being standardized and either identified or included in the package.

21. An article of manufacture containing packaged information objects wherein the package includes an identifier of the package object itself and the package is sealed by cryptographic message authentication.

22. The article of manufacture of claim (21), wherein the private key portion of a public/private key pair used for sealing is protected against misappropriation by use only in subsystems disconnected from networks and, optionally, is frequently replaced.

23. The article of manufacture of claim (21), wherein a public key associated with the claim (22) private key is published and optionally endorsed by a certificate signed by an institution other than that to which the keys alluded to in claim (22) belong, with this endorsing institution having a business dependency on its reputation for care, know-how, and integrity.

24. The article of manufacture of claim (21), including the package recording a link between two information objects by referencing their identifiers or indices.

25. The article of manufacture of claim (21), including within the package metadata recording a value that binds an external object defining a well-known ontology to an included payload element or link.

26. The article of manufacture of claim (21), wherein an information object X included in the package Z is itself packaged as described in claim (21) and wherein the identifier of Z alluded to in claim (21) has the same value as the identifier of X.

27. An article of manufacture that packages an information object together with metadata not otherwise provided, where such metadata includes software or instructions for interpretation of the information object, or alternatively contains a reference to a durable deposit of such software or instructions.

28. The article of manufacture of claim (27), wherein the information object and the information enabling its interpretation are bound together by a cryptographic message authentication code.

29. The article of manufacture of claim (27), wherein the software for interpretation is encoded with the instruction set of a machine, called a Universal Virtual Computer (UVC), that is simple enough so that it can be emulated without error or omission by any sufficiently skilled third party who has the specification of this UVC.

30. The article of manufacture of claim (27), wherein the software and instructions alluded to implement well-known methods that are made interpretable by their schema being standardized and identified or included in the package.
